(19) United States
(12) Patent Application Publication
(10) Pub. No.: US 2015/0061205 A1
(43) Pub. Date: Mar. 5, 2015

(54) Gripping device

(71) Applicant: Schunk GmbH & Co. KG Spann- und Greiftechnik, Lauffen am Neckar (DE)

(72) Inventor: Ralf Becker, Marbach (DE)

(21) Appl. No.: 14/474,200

(22) Filed: Sep. 1, 2014

(30) Foreign Application Priority Data
Sep. 3, 2013 (DE) 10 2013 217 474.8

(51) Int. Cl. B25B 5/02

(52) U.S. Cl. CPC B25B 5/02
USPC 269/256

(57) ABSTRACT

Gripping device (10) with a housing (12) and with at least one jaw (14, 16) in the housing (12), which can be moved along a travel direction (17), characterized in that the jaw (14, 16) has a piston section (22) that limits a pressure space (28, 30) provided in the housing (12), and that the jaw (14, 16) has an end section (18) with a circular cross-section, which reaches through the housing, wherein the end section (18) is disposed eccentrically with respect to the piston section (22).

### BACKGROUND OF THE INVENTION

The invention relates to a gripping device with a housing and at least one jaw that can be moved along a travel direction inside a housing. Objects can be gripped or clamped with such gripping devices. Such gripping devices are known, for example, from DE 197 04 444 C1 or DE 196 04649 C2. A gripping device is known from US 2001/0024045 A1, which provides a pin that protrudes perpendicularly from a piston.

The object of this invention is to propose a gripping device of the type described in the introduction, which has a comparatively simple structure, which has sufficiently strong gripping forces and with which objects can be reliably gripped or clamped.

### SUMMARY OF THE INVENTION

This object is achieved with a gripping device having the characteristics of the independent claim. In such a gripping device, the jaw has a piston section that limits a pressure space provided in the housing. Furthermore, the jaw has an end section with a circular cross-section, which reaches through the housing, wherein the end section is disposed eccentrically with respect to the piston section. Consequently, the central longitudinal axis of the end section is disposed parallel and offset from the central longitudinal axis of the piston section. As a result, transverse forces introduced into the end section can be directed via the piston section into the housing, providing protection against rotation. Because the end section has a circular cross-section, it is still possible to provide sufficient sealing between the end section and the housing.

It is possible for the piston section to have an outer surface and the end section to have an outer surface, wherein the outer surface of the piston section extends outside of the outer surface of the end section. The outer surface of the end section is then located inside the outer surface of the piston section.

Further, it is advantageous if the cross-section of the piston section is circular, oval, or rectangular with rounded edges. Even if the cross-section of the piston section is circular, transverse forces introduced into the end section can be reliably directed into the housing via the piston section. By providing a rectangular cross-section with rounded edges in combination with a housing with a rectangular cross-section, the power density of the gripping device can be increased.

In an advantageous embodiment, two jaws are provided, which can be moved along the travel direction toward and away from each other, and each of which has a contact section that extends along the travel direction such that both of the contact sections are suitable for supporting each other. Support can be provided by indirect means, for example, with sliding elements or casters, or by direct means. The contact sections are preferably located in a central longitudinal axis of the piston section and of the end section. When the jaws move, the two jaws, in particular in the region of their contact sections, slide directly against each other. Because they slide directly against each other, the jaws are prevented from rotating around their longitudinal axis or around the longitudinal axis of the end section. Transverse forces acting on an end section are then directed not only into the housing via the eccentricity of the end section and piston section but also into the other jaw via the contact sections.

Moreover, it is conceivable to provide a supporting element in the housing, which engages in a guide section on the jaw that extends in the travel direction. In this way, too, transverse forces acting on the end section can be directed into the housing.

The supporting element can be disposed transversely with respect to the travel direction of the jaw and extend, at least in sections, through at least the one jaw. If two jaws are provided, the supporting element can extend through both jaws, in particular, in the region of the contact sections of the jaws. Each one of the section elements will then serve to support the anti-rotation protection of the end sections of both jaws. The supporting element can be constituted like a bolt and preferably have a circular cross-section and/or a flattened cross-section. In particular, in the region in which it interacts with the jaws, it can be constituted flattened with two contact surfaces that extend parallel to each other. Because of the enlarged contact surface between the supporting element and the jaws, lower surface pressure can be achieved.

The supporting element constituted, in particular, like a bolt can have an adjustment section that interacts with the jaws such that the two jaws are moved synchronously. The adjustment section therefore interacts with both jaws. In particular, it can be constituted to rotate around the longitudinal axis of the bolt-like supporting element. On the one hand, it is conceivable for the adjustment section to be constituted to rotate on the supporting element. On the other hand, it is conceivable for the supporting element together with the adjustment section to rotate around the longitudinal axis of the supporting element. If the supporting element is constituted flattened in the region of the jaws with mutually opposite contact surfaces, rotation of the supporting element around the longitudinal axis is not possible; in that case, the adjustment section must be constituted to rotate around the supporting element.

For the purposes of motion coupling of the jaws over the adjustment section, it is advantageous if both sides of the contact sections that face each other have a recess and if the adjustment section is disposed in the region of this recess. The adjustment section can have guidance pins that extend transversely with respect to the travel direction, which interact with guidance grooves on the jaw, which are disposed in the respective recess. Preferably, the configuration is such that whenever the jaws are moved toward or away from each other, the adjustment section is rotated around the longitudinal axis of the supporting element. When the adjustment section rotates, the guidance pins therefore move along a circular segment. The guidance pins preferably extend along a straight line, which extends perpendicular to the supporting element.

Further advantages and advantageous embodiments of the invention are to be found in the following description based on which examples of the invention are described and explained in more detail. The figures show:

### BRIEF DESCRIPTION OF THE DRAWING

FIG. 1 a longitudinal section through a gripping device with extended jaws;

FIG. 2 the jaws of the gripping device according to FIG. 1 without housing;

FIG. 3 a section according to FIG. 1 with jaws retracted;

FIG. 4 the jaws according to FIG. 3 without housing;

FIG. 5 a jaw shown as a single part;

FIG. 6 a side view of the supporting element according to FIGS. 1 to 4,

FIG. 7 a longitudinal section through a further embodiment of an inventive gripping device,

FIG. 8 a further longitudinal section through the gripping device according to FIG. 8, and

FIG. 9 the supporting element of the gripping device according to FIG. 7 shown as a single part.

### DESCRIPTION OF THE PREFERRED EMBODIMENT

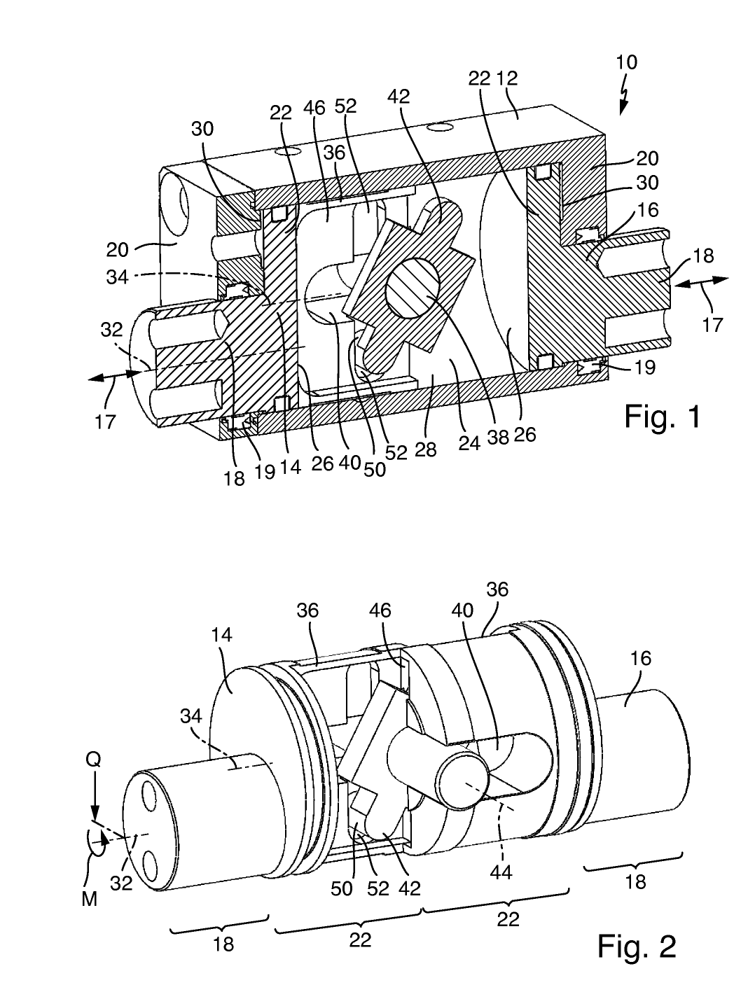

FIGS. 1 to 4 show a gripping device 10 with a housing 12 and two jaws 14, 16 in housing 12, which can be moved toward and away from each other. The jaws 14, 16 have a cylindrical (in cross-section circular) end section 18, each of which reaches through the respective end face 20 of the housing 12. Ring-like sealing elements 19 are provided around the end sections 18 to prevent media from entering the housing 12. The respective jaws 14, 16 also comprise a piston section 22, which remains in the housing 12. The respective piston sections 22 are provided in a cylinder space 24. Pressure can be applied to each of the two piston sections 22, wherein the piston section sides 26 that face each other delimit a common pressure space 28. When pressure is applied to the pressure space 28, the jaws 14, 16 move away from each other along their travel direction 17.

The piston sections 22 each delimit a pressure space 30 on the sides facing away from the pressure space 28. When pressure is applied to the pressure spaces 30, for example, by a common pressure tube, and when pressure space 28 is depressurized, the jaws move toward each other.

As can be seen in particular in FIGS. 2, 4, and 5, the respective end section 18 is disposed eccentrically with respect to the respective piston section 22, while the central longitudinal axis 32 of the respective end section 18 is disposed offset from the central longitudinal axis 34 of the respective piston section 22. In this way, when transverse forces Q occur, i.e. forces that produce a torque M around the central longitudinal axis 32 of the end section 18, rotation of the end section 18 in housing 12 can be prevented. Transverse forces Q occurring at the end section 18 are directed via the respective piston section 22 into the housing 12. Moreover, the two jaws 14, 16 each have a contact section 36 that extends in the travel direction 17, wherein the contact sections 36 of the two jaws support each other. The contact sections 36 are then in a plane that extends in the longitudinal direction, through the central longitudinal axes 34 and 32. Further anti-rotation protection of the end sections 18 can be achieved by the mutual support of the jaws 14, 16 in the region of the contact sections 36.

As is furthermore apparent from FIGS. 1 to 4, a supporting element 38 is provided, which is constituted like a bolt and which extends transversely with respect to the travel direction 17. The supporting element 38 extends through the piston sections 22 of the jaws and runs perpendicular to the contact sections 36. The jaws 14, 16 provide groove-like guidance sections 40, in which the supporting element 38 is disposed. Comparatively little play is provided between the section elements 38 and the groove-like guidance sections 40, so that the interplay between the supporting element 38 and the jaw sections surrounding the groove-like guidance sections 40 support anti-rotation protection of the end sections 18.

To synchronize the movement of the jaws 14, 16, an adjustment section 42 is provided at the supporting element 38. The adjustment section 42 is rotatably disposed around the central longitudinal axis 44 of the supporting element 38.

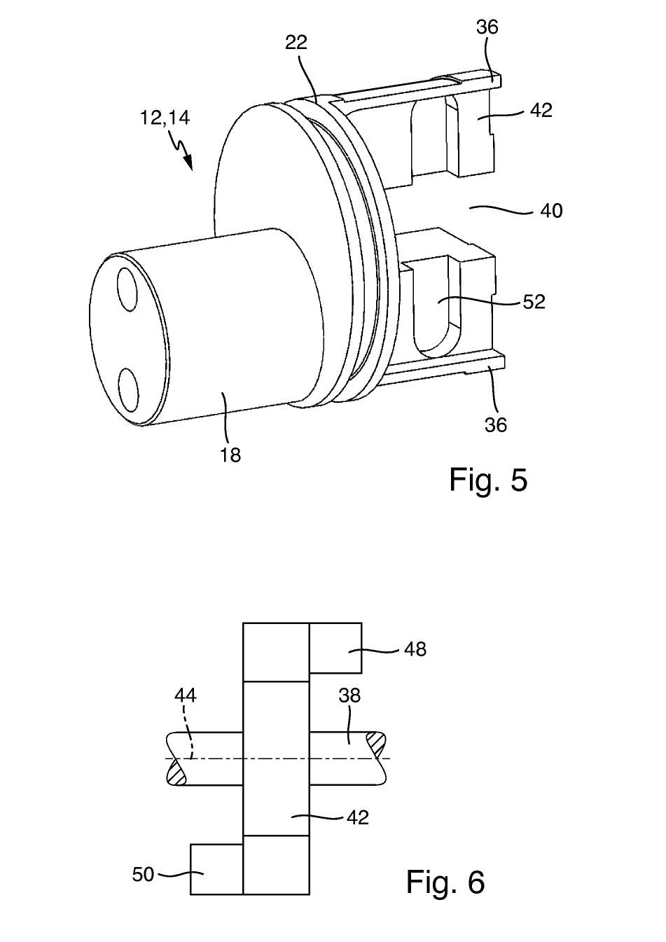

Furthermore, as is clear from FIGS. 1 to 3, the adjustment section 42 is provided in a recess 46 of the contact sections 36 facing each other. As FIG. 6 furthermore shows, the adjustment section 42 has guidance pins 48 and 50 at its diametrically opposed end sections, which extend in the direction of the central longitudinal axis 44 of the section element 38. The guidance pins 48, 50 reach into guidance grooves 52 (clearly visible in FIG. 5 on the jaw side), each of which is located in the region of the recess 46.

Another advantage of the gripping device shown in the figures is that the two jaws 14, 16 are constituted identically, which reduces costs in series production.

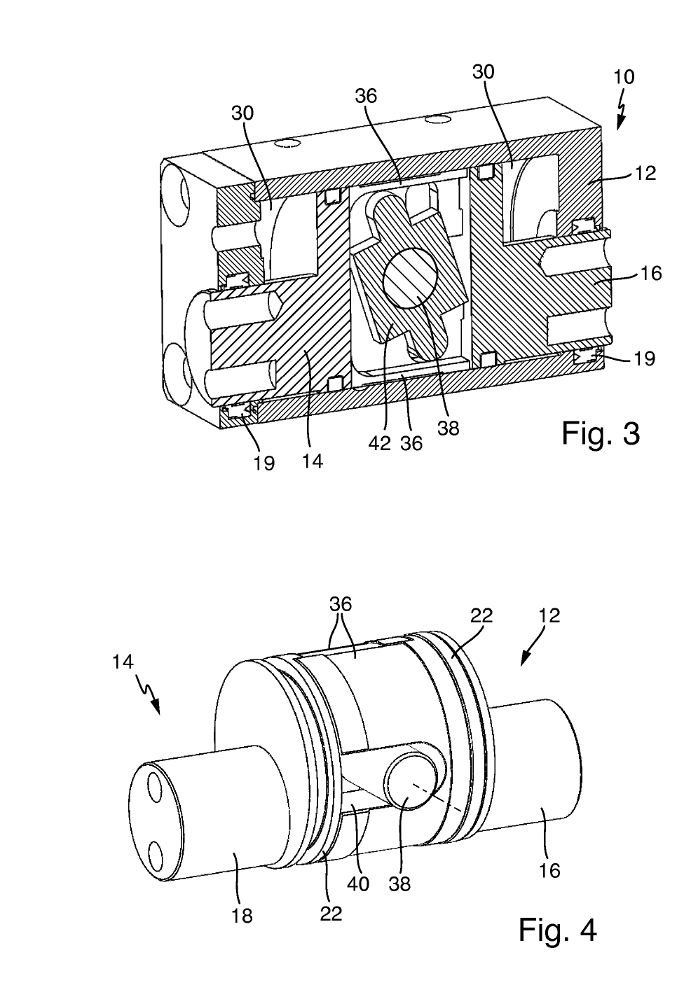

Starting from the extended final position of the jaws 14, 16 shown in FIG. 1, when pressure is applied to pressure spaces 30 and when pressure space 28 is depressurized, jaws 14, 16 or the end sections 18 of jaws 14, 16 are moved toward each other. This results in the adjustment section 42 being rotated around axis 44; the guidance pins 48, 50 therefore move around a circular path. Because the guidance pins 48, 50 are disposed captively in the respective guidance grooves 52, they move, starting from the position shown in FIG. 1, initially within the respective guidance grooves 52 away from the central longitudinal axis 34 until they reach a middle position and then back towards the central longitudinal axis 34, until they reach the end position shown in FIG. 3. The totality of these movements can result in synchronization of the movement of the jaws 14, 16. The clamping device represented in the figures consequently has the advantage that comparatively large gripping and clamping forces can be provided when adequate pressure is applied to the pressure spaces 30, 28. Moreover, reliable anti-rotation protection of the jaws 14, 16 can be achieved in the basic housing, wherein the jaws are also moved synchronously.

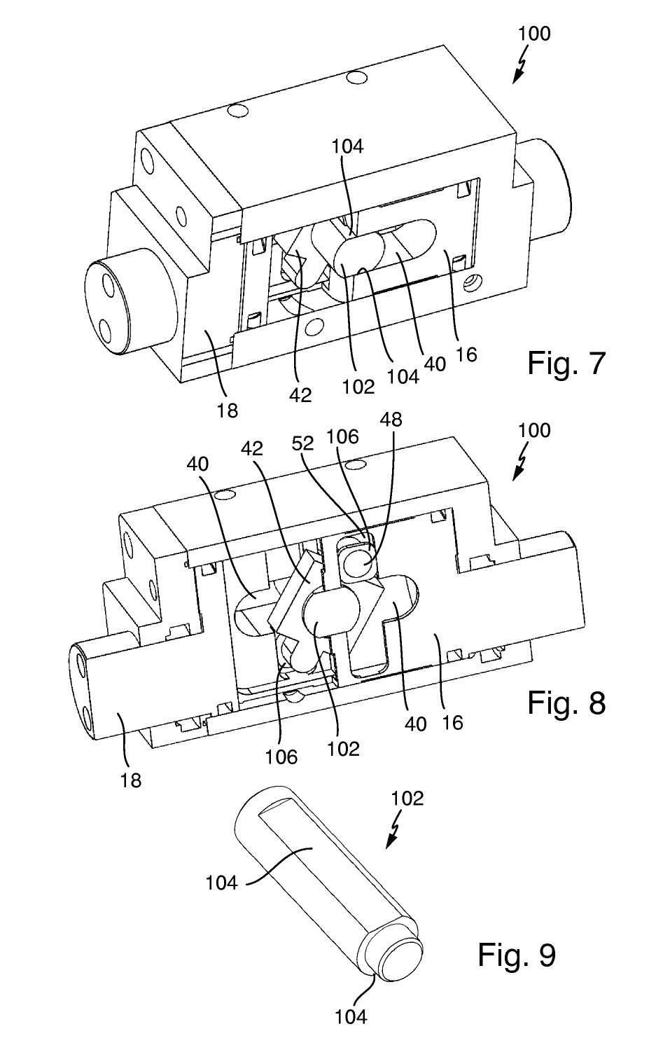

The gripping device 100 depicted in FIG. 7 and essentially corresponds to gripping device 10 according to FIGS. 1 to 6, wherein the relevant components are assigned reference numbers. The gripping device 100 differs from the gripping device 10 shown in FIGS. 1 to 5 by the fact that the bolt-like supporting element 102 is flattened. In particular, in the region in which the supporting element interacts with the jaws, it has two contact surfaces 104 that extend parallel to each other. The distance between the contact surfaces 102 is slightly smaller than the aperture dimension of the guidance sections 40 that take up the supporting element 102. As a result, a larger supporting surface between the supporting element 102 and the jaws 16, 18 is provided, wherein a lower surface pressure between the supporting element 102 and the jaws when traversing the jaws 16, 18 can be implemented.

As FIG. 8 clearly shows, the guidance pins 48, 50 of gripping device 100 have, in the regions in which they engage with the guidance grooves 52, a substantially rectangular sliding piece 106 rotatably disposed on the guidance pins 48, 50. The sliding piece 106 has a width that is slightly smaller than the aperture dimension of the guidance grooves 52. As a result, improved sliding characteristics and, in particular, a lower surface pressure between the guidance pins 48, 50 and jaws 16, 18 can be provided.

I claim:

1-13. (canceled)

14. A gripping device comprising:
a housing having a pressure space; and
at least one jaw, said jaw disposed, structured and dimensioned for movement within said housing along a travel direction, said jaw comprising a piston section limiting said pressure space of said housing, said piston section having an axis, wherein said jaw further comprises an end section of cylindrical cross-section, which reaches through said housing, said end section having an axis that extends offset from and parallel to said axis of said piston section, wherein said end section is thereby disposed eccentrically with respect to said piston section.

15. The gripping device of claim 14, wherein said piston section has an outer surface and said end section has an outer surface, said outer surface of said piston section extending outside of said outer surface of said end section.

16. The gripping device of claim 14, wherein a cross-section of said piston section and/or of said end section is round, circular, oval or rectangular with rounded edges.

17. The gripping device of claim 14, wherein the device comprises two jaws, which can be moved along said travel direction, toward and away from each other, each of said two jaws having a contact section that extends along said travel direction, said contact sections of said two jaws thereby being disposed, structured and dimensioned to support each other.

18. The gripping device of claim 14, further comprising a supporting element disposed in said housing, said supporting element engaging in a guide section of said jaw which extends in said travel direction.

19. The gripping device of claim 17, further comprising a supporting element disposed in said housing, said supporting element engaging in a guide section of said jaw which extends in said travel direction.

20. The gripping device of claim 18, wherein said supporting element is disposed transversely with respect to said travel direction, said supporting element having at least one section that extends through said jaw.

21. The gripping device of claim 19, wherein said supporting element is disposed perpendicular to and reaches through said contact sections.

22. The gripping device of claim 18, wherein said supporting element is constituted like a bolt and/or is flattened in a region of interaction with said jaw.

23. The gripping device of claim 19, wherein said supporting element has an adjustment section that interacts with said two jaws such that said two jaws are moved synchronously.

24. The gripping device of claim 23, wherein two sides of said contact sections facing each other define a recess in a region of which said adjustment section is disposed.

25. The gripping device of claim 23, wherein said adjustment section has guidance pins extending transversely with respect to said travel direction, said guidance pins interacting with guidance grooves in said jaws.

26. The gripping device of claim 25, wherein, when said adjustment section rotates, said guidance pins move along a circular segment, said guidance grooves thereby extending along a straight line perpendicular to said travel direction.

27. The gripping device of claim 25, wherein said guidance pins have rotatably disposed sliding pieces, which are guided in said guidance grooves.
